(19) United States
(12) Patent Application Publication
(10) Pub. No.: US 2007/0259195 A1
(43) Pub. Date: Nov. 8, 2007

(54) Polylactic acid composition, transparent heat resistant biodegradable molded article made of the same, and method for making the article

(75) Inventors: Ming-Tse Chou, Chung-Li City (TW); Li-Ling Chang, Tai Shan Hsiang (TW); Roy Wu, Chung-Li City (TW)

Correspondence Address: FOLEY AND LARDNER LLP;SUITE 500, 3000 K STREET NW, WASHINGTON, DC, 20007, US

(73) Assignee: FAR EASTERN TEXTILE LTD.

(21) Appl. No.: 11/797,577

(22) Filed: May 4, 2007

(30) Foreign Application Priority Data
May 8, 2006 (TW) 095116224

(51) Int. Cl. B32B 27/36; C08L 67/00; C08G 65/00

(52) U.S. Cl. 428/480; 525/439

(57) ABSTRACT

A polylactic acid composition includes polylactic acid, and a biodegradable nucleating polymer in an amount from 0.1 to 10 wt %, based on the total weight of the polylactic acid composition. The biodegradable nucleating polymer is used as a nucleating agent, and is selected from the group of aliphatic polyester other than polylactic acid, aliphatic-aromatic copolyester, and polyethylene glycol.

### CROSS-REFERENCE TO RELATED APPLICATION

This application claims priority of Taiwanese Application No. 095116224, filed on May 8, 2006.

### BACKGROUND OF THE INVENTION

1. Field of the Invention

The invention relates to a polylactic acid composition which can be used to form a transparent heat resistant biodegradable molded article, and which can reduce a molding cycle time for molding the article. The invention also relates to the article and the method for making the article. Furthermore, the invention also relates to a laminated article which includes a laminating film made of the polylactic acid composition.

2. Description of the Related Art

Plastic products have replaced metal or wood products for use as packaging materials, containers for food and detergent, and various household products because of the properties of low costs, fast production, and the like.

However, the treatment and disposal of the used plastic products are major issues in environment protection. There are usually three types of treatment for the used plastic products, i.e., incineration, burial, and recovery. The incineration method will produce poisonous substances (such as dioxin, chlorinated water, and the like), which are harmful for the environment, and a relatively large amount of combustion heat, which may reduce the service life of the incinerator. The burial method requires a large site for burying the waste, and the service life thereof is reduced due to the difficulty of decomposition of the plastic material. As for the recovery method, it is not easy to perform effectively.

Therefore, various biodegradable polymers have been developed in recent years for replacing the conventional plastic material in order to solve the environmental problems caused by the conventional plastic material. The commercially available biodegradable polymers include polycaprolactone, polyvinyl alcohol, polylactic acid, and the like. Among these polymers, polylactic acid is a preferred material because polylactic acid can be obtained from reproducible plant materials, such as corn starch, sugar beet, and the like. Furthermore, the amount of the combustion heat produced from polylactic acid is relatively small, which is advantageous for the service life of the incinerator, and will not produce poisonous substances. Additionally, polylactic acid can maintain the performance thereof at ambient conditions, and can be biodegraded into water and carbon dioxide in a burial, elevated temperature, or humid environment. Therefore, the harmful impact to the environment can be reduced by using the polylactic acid.

However, the article made of polylactic acid is usually amorphous, and has an inferior heat resistance. Therefore, it is not suitable for use in an elevated temperature, for example, use as a container for hot food and drink or use in a microwave oven.

In order to improve the heat resistance of the article made of the polylactic acid, polylactic acid is crystallized in molding procedure or blended with inorganic nucleating agents, polyesters, or polyamides to increase the crystallinity of the polylactic acid.

However, the crystallization speed of polylactic acid in the molding procedure is low, and the period for maintaining polylactic acid at a crystallized temperature in a mold is long, which in turn reduces productivity and increases production cost.

The inorganic nucleating agents used in the art include calcium carbonate, talc, silicon dioxide, or kaolinite. Such inorganic nucleating agents will reduce the transparency of the article made therefrom.

Taiwanese Patent Publication No. 200402448 discloses a biodegradable sheet comprising 75-25 wt % of polylactic acid resin and 25-75 wt % of polyester. Although the article made of the biodegradable sheet has superior heat resistance and impact resistance, the transparency of the article is not satisfactory for the industrial practice because the amount of polyester contained in the biodegradable sheet is above 25 wt %.

U.S. Pat. No. 6,417,294 discloses a film or molded article of an aliphatic polyester having transparency and crystallinity in combination and comprising an aliphatic polyester and one or more transparent nucleating agents. The aliphatic polyester may be a homopolymer, such as polylactic acid, or a copolymer, such as a copolymer of lactic acid and glycolic acid. The nucleating agents are selected from the group consisting of aliphatic carboxylic acid amide, aliphatic carboxylic acid salt, aliphatic alcohol, and aliphatic carboxylic acid ester. Since the nucleating agents are monomer compounds having a relatively small molecular weight, they are liable to release from pellets of the aliphatic polyester upon storage and/or transport, and in turn reduce the crystallinity of the film or molded article made thereby. Furthermore, the nucleating agents are also liable to release from the film or molded article, and in turn pollute the contents packed in the film or molded article. Therefore, the film or molded article is not suitable for packing foods.

Taiwanese Patent Publication No. 200304473 discloses a lactic acid polymer composition comprising amidic compound as a transparent nucleating agent, ester plastifier as a crystallizing accelerator, and lactic acid polymer. However, the molding cycle time (or crystallization time) illustrated in the examples of the prior art is more than 2 minutes. It can not meet the requirement for industrial practice.

Therefore, it is desirable to provide a polylactic acid composition which has a relatively short molding cycle time for making a biodegradable article having improved transparent and heat resistant properties.

### SUMMARY OF THE INVENTION

Therefore, one object of the present invention is to provide a polylactic acid composition, which has a reduced molding cycle time for making a biodegradable article.

Another object of the present invention is to provide a biodegradable transparent heat resistant article made of the polylactic acid composition.

A further object of this invention is to provide a method for making the biodegradable transparent heat resistant article.

Still another object of this invention is to provide a laminated article including a film made of the polylactic acid composition.

In the first aspect of this invention, the polylactic acid composition according to this invention includes polylactic acid, and a biodegradable nucleating polymer in an amount from 0.1 to 10 wt %, based on the total weight of the polylactic acid composition. The biodegradable nucleating polymer is used as a nucleating agent for crystallizing the polylactic acid, and is selected from the group consisting of aliphatic polyester other than polylactic acid, aliphatic-aromatic copolyester, and polyethylene glycol.

In the second aspect of this invention, the biodegradable transparent heat resistant article according to this invention comprises a crystallized and molded sheet made of a polylactic acid composition that includes polylactic acid, and a biodegradable nucleating polymer in an amount from 0.1 to 10 wt %, based on the total weight of the polylactic acid composition. The biodegradable nucleating polymer is used as a nucleating agent for crystallizing the polylactic acid, and is selected from the group consisting of aliphatic polyester other than polylactic acid, aliphatic-aromatic copolyester, and polyethylene glycol.

In the third aspect of this invention, the method for making a biodegradable transparent heat resistant article according to this invention includes the steps of:

a) blending polylactic acid with a biodegradable nucleating polymer to form a polylactic acid composition, the biodegradable nucleating polymer being used as a nucleating agent in an amount from 0.1 to 10 wt %, based on the total weight of the polylactic acid composition, and being selected from the group consisting of aliphatic polyester other than polylactic acid, aliphatic-aromatic copolyester, and polyethylene glycol;

b) forming the polylactic acid composition into a sheet; and

c) heating the sheet for crystallization, the crystallization being conducted at a temperature ranging from a temperature of 5° C. higher than the glass transition temperature of the polylactic acid composition to a temperature of 5° C. lower than the melting point of the polylactic acid composition.

In the fourth aspect of this invention, a laminated article includes a substrate, and a film made of the polylactic acid composition and laminated on the substrate.

### DETAILED DESCRIPTION OF THE PREFERRED EMBODIMENTS

The biodegradable nucleating polymer added in the polylactic acid composition of the present invention is in an amount from 0.1 to 10 wt %, preferably in an amount of from 0.3 to 5 wt %, based on the total weight of the polylactic acid composition. If the amount of the biodegradable nucleating polymer in the polylactic acid composition is less than 0.1 wt %, the crystallization effect achieved thereby is not satisfactory. On the contrary, if the amount of the biodegradable nucleating polymer in the polylactic acid composition is more than 10 wt %, the transparency achieved thereby is not satisfactory for the industrial practice. The biodegradable nucleating polymer is used as a nucleating agent in the polylactic acid composition of the present invention. The biodegradable nucleating polymer suitable for this invention is aliphatic polyester other than polylactic acid, aliphatic-aromatic copolyester, polyethylene glycol, or combinations thereof.

Polylactic acid suitable for the present invention has a weight average molecular weight ranging from 40,000 to 800,000, preferably from 50,000 to 400,000. If the weight average molecular weight of polylactic acid is less than 40,000, the properties such as mechanical property and the heat resistance are not satisfactory for the industrial practice. On the contrary, if the weight average molecular weight of polylactic acid is more than 800,000, the processibility is inferior due to relatively high melting point and viscosity of the polylactic acid.

The aliphatic polyester suitable for the present invention is represented by formula (I):

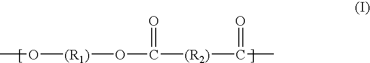

wherein R₁ and R₂ are the same or different, and are independently linear or branched C₂-C₄₀ alkyl. Preferably, the aliphatic polyester has a melting point ranging from 30 to 140° C., and the examples thereof are polybutylene adipate (e.g., FEPOL1000, a series of products from Far Eastern Textile, Taiwan), polybutylene succinate (e.g., Bionolle® 1000 series from Showa High Polymer Co., Ltd.), polybutylene succinate/adipate (e.g., Bionolle® 3000 series from Showa High Polymer Co., Lt.d), polyethylene succinate/adipate, polybutylene succinate/carbonate, polycaprolactone, polyethylene adipate, and the like.

The aliphatic-aromatic copolyester suitable for the present invention is represented by formula (II):

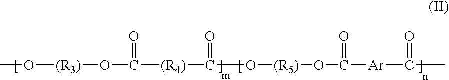

wherein
m is from 0.1 mol % to 99.9 mol %;
n is from 0.1 mol % to 99.9 mol %;
m+n is 100 mol %;
R₃, R₄, and R₅ are the same or different, R₃ and R₅ are independently linear or branched C₂-C₂₀ alkyl, and R₄ is linear or branched C₃-C₄₀ alkyl; and
Ar is C₆-C₂₀ aryl.

Preferably, the aliphatic-aromatic copolyester has a melting point ranging from 50 to 200° C., and the examples thereof are polybutylene adipate/terephthalate (e.g., FEPOL2000, a series of products from Far Eastern Textile, Taiwan, Ecoflex from BASF, or Enpol 8000 from IRE Chemicals Ltd.), polybutylene succinate/terephthalate (e.g., Biomax from DuPont), polytetramethylene adipate/terephthalate (e.g., EastarBio from Eastman Chemicals), and the like.

The polyethylene glycol suitable for the present invention has a melting point ranging from 20 to 80° C.

Furthermore, the polylactic acid composition of the present invention can include additives well known in the art. The examples of the additives are thermal stabilizer, colorant, antistatic agent, fire retardant, blowing agent, anti-UV stabilizer, anti-slip agent, plastifier, inorganic filler, antioxidant, lubricant, and the like.

The aforesaid polylactic acid and the aforesaid biodegradable nucleating polymer are blended to form the polylactic acid composition of the present invention, which may be extruded in a well known manner. For example, the polylactic acid composition may be extruded using a single or twin screw extruder, to form a bundle of strips, which may then be cut or pelletized to form particulates.

The particulates of the polylactic acid composition may be formed, for example, by extruding into a sheet, which may be further processed via any suitable molding process, such as vacuum molding, to provide molded articles. The sheet can be crystallized by heat. The crystallization may be conducted by heating at a temperature ranging from a temperature of 5° C. higher than the glass transition temperature of the polylactic acid composition to a temperature of 5° C. lower than the melting point of the polylactic acid composition. Preferably, the crystallization is conducted at a temperature ranging from 90 to 135° C. The molding step can be conducted after the crystallization, or can be conducted while heating the sheet for the crystallization.

Additionally, the polylactic acid composition of this invention can be laminated on a substrate by a laminating machine to form a laminated pre-product, which is further crystallized by heat to produce a laminated article including a film of the polylactic acid composition laminated on the substrate. The substrate can be a fibrous sheet, e.g., a paper sheet. The laminated article can be used as a biodegradable heat resistant container for beverage or food, especially for hot beverage and food, and the examples thereof are a paper cup, a paper lunch box, etc.

As described above, the crystallization for the film of the polylactic acid composition laminated on the substrate may be conducted by heating at a temperature ranging from a temperature of 5° C. higher than the glass transition temperature of the polylactic acid composition to a temperature of 5° C. lower than the melting point of the polylactic acid composition. Preferably, the crystallization is conducted at a temperature ranging from 90 to 135° C.

The crystallization for the biodegradable heat resistant article of the present invention can be conducted for a period less than 2 minutes. The haze value of the molded article or the film on the substrate is less than 90%, i.e., the molded article or the film is transparent.

The following examples are provided to illustrate the preferred embodiments of the invention, and should not be construed as limiting the scope of the invention.

### EXAMPLES

Chemicals and devices used in the examples:
1. Polylactic acid: manufactured by Nature Works, U.S.A., melting point: 169° C., glass transition temperature: 57° C.
2. Biodegradable polybutylene adipate: FEPOL1000 from Far Eastern Textile, Taiwan, melting point: 60° C.
3. Biodegradable polybutylene adipate/terephthalate: FEPOL2040 from Far Eastern Textile, Taiwan, melting point: 140° C., glass transition temperature: ˜10° C.
4. Biodegradable polybutylene adipate/terephthalate: Ecoflex from BASF, melting point: 109° C., glass transition temperature: ˜−10° C.
5. Biodegradable polybutylene succinate/terephthalate: Biomax from DuPont, melting point: 170° C., glass transition temperature: 70° C.
6. polyethylene glycol: manufactured by En Hou Polymer Chemical Industrial Co., Ltd., Taiwan, melting point: 28° C.
7. twin screw extruder: manufactured by JSW Company.
8. Differential Scanning Calorimeter (DSC): manufactured by Perkin-Elmer Company.
9. Haze Meter: manufactured by Turbidity Company.

### Example A

Polylactic acid and FEPOL1000 were blended in a weight ratio shown in Table 1 to obtain a blend having a total weight of 200 kg. The blend was mixed dispersively and extruded in a twin screw extruder to obtain strips, which were pelletized to obtain pellets. The operating conditions of the extruder were as follows: L/D ratio≈32, rotating speed of the screw≈200 rpm, temperature distribution of the screw≈190° C., 195° C., 195° C., 195° C., and 190° C., and die temperature≈190° C.

The particulates were dried at 70° C. for 12 hours, and were supplied to a single screw extruder to form a sheet having a thickness of 0.4 mm through a T-die. At this time, the crystallinity of the sheet was 0%. The sheet was vacuum formed at a vacuum degree of −70 cm-Hg or pressure formed at a pressure of 5 kg in a mold to obtain an article. The mold had a width of 90 mm, a depth of 75 mm, and a draw ratio of 2.6. The molding temperature was 120° C.

The properties of the molded articles are shown in Table 1. The crystallinity and crystallization rate were measured by DSC. The crystallinity is defined by ΔH/ΔHf, in which ΔH is measured heat of fusion of a tested sample, and ΔHf is heat of fusion of 100% crystallinity polymer. ΔHf for polylactic acid is 93 J/g. The rate of crystallization is a half-life time of crystallization, i.e., the time period for attaining 50% crystallinity. DSC measurement is conducted by heating a particulate sample in DSC to 200° C. rapidly and keeping the sample at 200° C. for 5 minutes to remove the heat history of the sample, quenching the sample at a rate of 200° C./min after melting to reach an amorphous state, and heating rapidly to a crystallization temperature for 30 minutes to crystallize polylactic acid composition completely. The crystallization temperature of the example was set to 120° C. Vicat temperature was measured according to ASTM 1525. Haze analysis was measured by a haze meter.

### Comparative Example a

Example A was repeated except that the weight ratio of polylactic acid and FEPOL1000 shown in Table 2 was used. The properties of the molded article are shown in Table 2.

### Example B

Example A was repeated except that FEPOL1000 used in Example A was replaced with FEPOL2040. The weight ratio of polylactic acid and FEPOL2040 used in the Example B and the properties of the molded article are shown in Table 3.

### Examples C, D and E

The procedures of Examples C, D, and E were substantially identical to that of Example A except that FEPOL1000 was replaced with Ecoflex, Biomax, and polyethylene glycol, respectively. The weight ratio of components used in the Examples C, D, and E and the properties of the molded articles are shown in Table 4.

### Comparative Example b, b′, and c

The procedures of Comparative examples b, b′ and c were substantially identical to that of Example A except that no nucleating agent was added in Comparative examples b and b′ and that 10 wt % of CaCO₃ was used as the nucleating agent in Comparative example c to substitute for FEPOL1000 used in Example A. The weight ratio of components used in the Comparative examples b, b′, and c and the properties of the molded articles are shown in Table 4. The difference between Comparative example b and Comparative example b′ is the forming temperature. The forming temperature for Comparative example b′ is 25° C., and the obtained article is transparent and not crystallized.

TABLE 1
Example A

| No. | | A1 | A2 | A3 | A4 | A5 |
|---|---|---|---|---|---|---|
| Wt % | PLA | 99.9 | 99.7 | 97.0 | 95.0 | 90.0 |
| | F1000 | 0.1 | 0.3 | 3.0 | 5.0 | 10.0 |

| | | | | | |
|---|---|---|---|---|---|
| Forming temperature | 120 | 120 | 120 | 120 | 120 |
| (° C.) | | | | | |
| Crystallization rate | 0.750 | 0.467 | 0.467 | 0.367 | 0.367 |
| (min) | | | | | |
| Crystallinity (%) | 44.9 | 52.5 | 47.1 | 46.5 | 43.7 |
| Vicat temperature (° C.) | 155 | 156 | 158 | 158 | 157 |
| Haze (%) | 2.36 | 6.47 | 34.53 | 72.30 | 87.42 |

* PLA: polylactic acid; F1000: FEPOL1000 (polybutylene adipate) from Far Eastern Textile, Taiwan.

TABLE 2
Comparative Example

No.

| | | | |
|---|---|---|---|
| a1 | a2 | a3 | a4 |

| | | | | | |
|---|---|---|---|---|---|
| Wt % | PLA | 85.0 | 80.0 | 75.0 | 70.0 |
| | F1000 | 15.0 | 20.0 | 25.0 | 30.0 |

| | | | | |
|---|---|---|---|---|
| Forming | 120 | 120 | 120 | 120 |
| temperature (° C.) | | | | |
| Crystallization | 0.467 | 0.467 | 0.450 | 0.483 |
| rate (min) | | | | |
| Crystallinity (%) | 43.1 | 40.8 | 38.8 | 37.6 |
| Vicat temperature | 158 | 157 | 158 | 158 |
| (° C.) | | | | |
| Haze (%) | 91.87 | 91.50 | 91.83 | 91.12 |

TABLE 3
Example B

| | | No. | | |
|---|---|---|---|---|
| | | B1 | B2 | B3 |
| Wt % | PLA | 99.9 | 99.7 | 97.0 |
| | F2040 | 0.1 | 0.3 | 3.0 |

| | | | |
|---|---|---|---|
| Forming temperature | 120 | 120 | 120 |
| (° C.) | | | |
| Crystallization rate | 1.12 | 0.817 | 0.833 |
| (min) | | | |
| Crystallinity (%) | 40.9 | 52.9 | 49.9 |
| Vicat temperature (° C.) | 157.9 | 158.3 | 157.3 |
| Haze (%) | 2.56 | 11.14 | 69.11 |

*F2040: FEPOL2040 (polybutylene adipate/terephthalate) from Far Eastern Textile, Taiwan.

TABLE 4

| | | Examples | | | Comparative Examples | | |
|---|---|---|---|---|---|---|---|
| No. | | C | D | E | b | b′ | c |
| Wt % | PLA | 97.0 | 97.0 | 97.0 | 100 | 100 | 90.0 |
| | * | 3.0*^{C} | 3.0*^{D} | 3.0*^{E} | — | — | — |
| | CaCO₃ | — | — | — | — | — | 10.0 |

| | | | | | | |
|---|---|---|---|---|---|---|
| Forming | 120 | 120 | 120 | 120 | 25 | 120 |
| temperature | | | | | | |
| (° C.) | | | | | | |
| Crystallization | 0.817 | 1.3 | 1.0 | 3.5 | — | 0.8 |
| rate (min) | | | | | | |
| Crystallinity | 49.1 | 49.3 | 56.9 | 41.1 | — | 29.2 |
| (%) | | | | | | |
| Vicat | 157.6 | 158.2 | 156.0 | 78.9 | 48.4 | 157 |
| temperature | | | | | | |
| (° C.) | | | | | | |
| Haze (%) | 71.65 | 82.63 | 3.3 | 77.67 | 1.21 | 99.3 |

*^{C}Ecoflex (polybutylene adipate/terephthalate) from BASF
*^{D}Biomax (polybutylene succinate/terephthalate) from DuPont
*^{E}polyethylene glycol

### Effects:

### Molding Cycle Time and Heat Resistance:

As shown in Tables 1, 2, 3, and 4, it is found from the comparison of Examples A, B, C, D, and E with Comparative Examples b and b′ that the crystallization rate of the Examples of the present invention is faster than that of the Comparative Examples. Most of the Examples of the present invention have the crystallization rate of less than one minute, and can reach as low as 0.367 minute. This means that the molding cycle time achieved by the present invention can be significantly reduced. Furthermore, the Vicat temperature (Softening point) of the Examples of the present invention is raised significantly as compared to the Comparative Examples b and b′. Therefore, the articles made by the polylactic acid composition of the present invention have significantly reduced molding cycle time and superior heat resistance.

### Influence of the Ratio of the Biodegradable Nucleating Polymer in the Polylactic Acid Composition on Transparency:

As shown in Table 1, when the biodegradable nucleating polymer of the polylactic acid composition is present in an amount less than 10 wt %, the haze is less than 90%, i.e., the articles are transparent. On the contrary, when the biodegradable nucleating polymer of the polylactic acid composition is present in an amount more than 10 wt %, the haze is more than 90%, which means that the articles have poor transparency.

### Comparison with Inorganic Nucleating Agent:

As shown in Tables 1, 3, and 4, it is found from the comparison of Examples A, B. C, D, and E with Comparative Example c (including 10 wt % CaCO₃) that the haze of Comparative Example c is as high as 99.3%, which means that the articles have no transparency. On the contrary, the haze of the Examples of the present invention are all less than 90%, which means that the articles are transparent. Therefore, the articles made from the polylactic acid composition of the present invention are transparent, while maintaining satisfactory crystallization rate and Vicat temperature.

### Heat Resistance:

The article of Example A3 and the article of Comparative Example b were filled with hot water at 100° C., respectively, and the amounts of deformation thereof were measured. It is shown from the measurement result that the article of Example A3 has substantially no deformation while the article of Comparative Example b shrank significantly. Therefore, the heat resistance of the article made of the polylactic acid composition of the present invention is improved significantly.

### Biodegradation:

The biodegradation properties of the polylactic acid composition were tested according to CNS 14432 (ISO 14855, ASTM D5338). The biodegradation rate obtained from the biodegradating test is based on the percentage of carbon dioxide converted from organic carbon contained in the tested polylactic acid composition. The result is shown in Table 5. It is found from the result shown in Table 5 that the biodegradation rate of the polylactic acid composition of the present invention can reach 90% in 180 days, which meets the statutory requirement.

TABLE 5
Example A3

| | Elapsed time (days) | | | | | | |
|---|---|---|---|---|---|---|---|
| | 0 | 10 | 20 | 30 | 40 | 50 | 53 |
| Biodegradation | 0 | 18.99 | 40.64 | 60.13 | 73.44 | 93.27 | 100 |
| (%)* | | | | | | | |

*measurement based on the carbon dioxide percentage converted from organic carbon contained in the polylactic acid composition.

### Examples F and G and Comparative Example d

### Production of Films from Polylactic Acid Composition

### Example F

The particles of the polylactic acid composition obtained in Example A3 were dried at 70° C. for 12 hours, and were supplied to an extrusion coating machine having a single screw. The polylactic acid composition was extruded onto a paper substrate of 340 gsm via a T-die to obtain a laminated biodegradable paper having a film with a thickness of 25 μum. The laminated biodegradable paper is heated at 120° C. for 30 seconds to crystallize the film of the polylactic acid composition and to enhance the heat resistance of the film.

### Example G

The procedure of Example G was substantially identical to that of Example F except that pellets of the polylactic acid composition of Example B3 were used to substitute for the pellets of the polylactic acid composition of Example A3 used in Example F.

### Comparative Example d

The procedure of Comparative Example d was substantially identical to that of Example F except that the pellets made of 100 wt % polylactic acid (i.e., containing no nucleating agent) were used to substitute for the pellets of the polylactic acid composition of Example A3 used in Example F.

### Heat Resistance of the Laminated Paper:

Four sets of specimens were obtained by cutting the laminated papers of Examples F and G and Comparative Example d. Each of the specimens has a size of 16×8 cm², and each set of the specimens includes each of the specimens of Examples F and G and Comparative Example d. Each set of the specimens were folded in half, and were pressed in a pressing machine under a pressing force of 100 kg/cm² at a particular temperature for a particular period, as shown in Table 6. Each of the pressed specimens was inspected whether it can be separated or not. If the folded specimen can be separated easily, it indicates that the laminating film had crystallized and thus can be separated easily after being compressed at a temperature above the glass transition temperature (Tg) of polylactic acid (Tg for polylactic acid is about 57° C.), which also indicates that the film has superior heat resistance.

TABLE 6

| Specimen | Temp. | | | | | Comp. |
|---|---|---|---|---|---|---|
| No. | (° C.) | Time | | Ex. F | Ex. G | Ex. d |
| 1 | 70 | 5 | sec | Separable | Separable | Stuck |
| 2 | 70 | 20 | min | Separable | Separable | Stuck |
| 3 | 80 | 5 | sec | Separable | Separable | Stuck |
| 4 | 80 | 20 | min | Separable | Separable | Stuck |

As shown in Table 6, the folded specimens obtained from the laminated papers of Examples F and G can be separated easily after pressing, indicating that the films of the laminated paper obtained in Examples F and G have been crystallized, and thus have superior heat resistance. Oppositely, the folded specimens obtained from the laminated papers of Comparative Example d are stuck after pressing, indicating that the films of the laminated paper obtained in Comparative Example d were not crystallized. Therefore, the results of Table 6 show that the film made of the polylactic acid composition of the present invention has a reduced molding cycle time and superior heat resistance, and that the polylactic acid composition of the present invention can be used as a film for making a biodegradable heat resistant container to contain beverage or food, especially for hot beverage or food.

In view of the aforesaid, the polylactic acid composition of the present invention has a relatively short molding cycle time, and the biodegradable article made therefrom has improved transparent, heat resistant, and biodegradable properties.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A polylactic acid composition for making a biodegradable transparent heat resistant article, comprising:
polylactic acid; and
a biodegradable nucleating polymer in an amount from 0.1 to 10 wt %, based on the total weight of said polylactic acid composition,
wherein said biodegradable nucleating polymer is used as a nucleating agent for crystallizing said polylactic acid and is selected from the group consisting of aliphatic polyester other than polylactic acid, aliphatic-aromatic copolyester, and polyethylene glycol.

2. The polylactic acid composition as claimed in claim 1, wherein said aliphatic polyester is represented by formula (I): 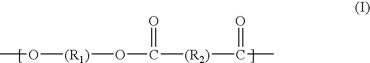
wherein R₁ and R₂ are the same or different, and independently of one another are linear or branched C₂-C₄₀ alkyl.

3. The polylactic acid composition as claimed in claim 1, wherein said aliphatic-aromatic copolyester is represented by formula (II): 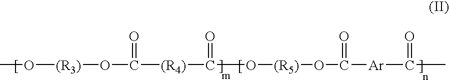
wherein
m is from 0.1 mol % to 99.9 mol %;
n is from 0.1 mol % to 99.9 mol %;
m+n is 100 mol %;
R₃, R₄, and R₅ are the same or different, R₃ and R₅ independently of one another are linear or branched C₂-C₂₀ alkyl, and R₄ is linear or branched C₃-C₄₀ alkyl; and
Ar is C₆-C₂₀ aryl.

4. The polylactic acid composition as claimed in claim 2, wherein said aliphatic polyester has a melting point ranging from 30 to 140° C.

5. The polylactic acid composition as claimed in claim 4, wherein said aliphatic polyester is selected from the group consisting of polybutylene adipate, polybutylene succinate, polybutylene succinate/adipate, polyethylene succinate/adipate, polybutylene succinate/carbonate, polycaprolactone, and polyethylene adipate,

6. The polylactic acid composition as claimed in claim 3, wherein said aliphatic-aromatic copolyester has a melting point ranging from 50 to 200° C.

7. The polylactic acid composition as claimed in claim 6, wherein said aliphatic-aromatic copolyester is selected from the group consisting of polybutylene adipate/terephthalate, polybutylene succinate/terephthalate, and polytetramethylene adipate/terephthalate.

8. The polylactic acid composition as claimed in claim 1, wherein said polyethylene glycol has a melting point ranging from 20 to 80° C.

9. The polylactic acid composition as claimed in claim 1, wherein said biodegradable nucleating polymer is in an amount from 0.3 to 5 wt %, based on the total weight of said polylactic acid composition.

10. The polylactic acid composition as claimed in claim 9, wherein said polylactic acid has a weight average molecular weight ranging from 40,000 to 800,000.

11. A transparent heat resistant biodegradable molded article, comprising a crystallized and molded sheet made of a polylactic acid composition including:
polylactic acid; and
a biodegradable nucleating polymer in an amount from 0.1 to 10 wt %, based on the total weight of said polylactic acid composition,
wherein said biodegradable nucleating polymer is used as a nucleating agent for crystallizing said polylactic acid and is selected from the group consisting of aliphatic polyester other than polylactic acid, aliphatic-aromatic copolyester, and polyethylene glycol.

12. The transparent heat resistant biodegradable molded article as claimed in claim 11, wherein said sheet has a haze value less than 90%.

13. A method for making a biodegradable transparent heat resistant article, comprising the steps of:
a) blending polylactic acid with a biodegradable nucleating polymer to form a polylactic acid composition, wherein the biodegradable nucleating polymer is used as a nucleating agent in an amount from 0.1 to 10 wt %, based on the total weight of the polylactic acid composition, and is selected from the group consisting of aliphatic polyester other than polylactic acid, aliphatic-aromatic copolyester, and polyethylene glycol;
b) forming the polylactic acid composition into a sheet; and
c) heating the sheet for crystallization, the crystallization being conducted at a temperature ranging from a temperature of 5° C. higher than the glass transition temperature of the polylactic acid composition to a temperature of 5° C. lower than the melting point of the polylactic acid composition.

14. The method as claimed in claim 13, wherein the crystallization is conducted for a period less than 2 minutes.

15. The method as claimed in claim 13, further comprising the step of molding the sheet after the crystallization.

16. The method as claimed in claim 13, further comprising the step of molding the sheet while heating the sheet for the crystallization.

17. The method as claimed in claim 13, wherein the crystallization is conducted at a temperature ranging from 90 to 135° C.

18. The method as claimed in claim 13, wherein the biodegradable nucleating polymer is used in an amount from 0.3 to 5 wt %, based on the total weight of the polylactic acid composition.

19. The method as claimed in claim 13, wherein the polylactic acid composition is formed into pellets before formed into the sheet, the sheet being formed from the pellets.

20. A laminated article, comprising a substrate, and a film made of a polylactic acid composition and laminated on said substrate, said polylactic acid composition including:
polylactic acid; and
a biodegradable nucleating polymer in an amount from 0.1 to 10 wt %, based on the total weight of said polylactic acid composition,
wherein said biodegradable nucleating polymer is used as a nucleating agent for crystallizing said polylactic acid and is selected from the group consisting of aliphatic polyester other than polylactic acid, aliphatic-aromatic copolyester, and polyethylene glycol.
